(19) United States
(12) Patent Application Publication
(10) Pub. No.: US 2014/0290172 A1
(43) Pub. Date: Oct. 2, 2014

(54) Construction System and Components Therefor

(71) Applicant: Reginald Arthur Richards, Christchurch (NZ)

(72) Inventor: Reginald Arthur Richards, Christchurch (NZ)

(73) Assignee: RCP Holdings Limited, Christchurch (NZ)

(21) Appl. No.: 13/995,799

(22) PCT Filed: Dec. 22, 2010
(86) PCT No.: PCT/IB2010/056002

§ 371 Date: Sep. 5, 2013

(30) Foreign Application Priority Data
Jan. 4, 2011 (EP) 11150073.2

(51) Int. Cl. E04C 2/04; E04B 7/20; E04B 2/06; E04B 5/02; F16L 5/00; E04B 1/04

(52) U.S. Cl. CPC E04C 2/044; F16L 5/00; E04B 1/04; E04B 2/06; E04B 5/02; E04B 7/20
USPC 52/578; 428/189; 428/70; 428/172; 428/174; 428/34.4; 428/157; 428/411.1; 137/360

(57) ABSTRACT

A presence detection system for detecting presence of a living being (2) within an area (4), the system comprising a first light source (6a) providing light of a first spectrum, a first sensing means (8a; 10a) which is arranged to filter the light of the first spectrum. The first sensing means produces a first presence detection signal (12a) based on the light of the first spectrum originated from the first light source and reflected from the living being (2). The presence detection system comprises a processor device (14) for concluding the living being's presence within the area (4) based on the first presence detection signal (12a). The processor device provides a position (22a) of the living being (2) within the area based on the intensity of the first presence detection signal (12a) and based on the known position of the first light source (6a) within the area (4). The invention further relates to a lighting system comprising the above described presence detection system.

### FIELD OF THE INVENTION

The invention relates to a presence detection system for detecting presence of a person within an area. The system comprises a light source providing light and a sensing means which is arranged to produce a presence detection signal based on the light originated from the light source and reflected from the person. The system further comprises a processor device for concluding the person's presence within the area based on the presence detection signal.

The invention further relates to a lighting system comprising the above mentioned presence detection system.

### BACKGROUND OF THE INVENTION

An embodiment of such a system is disclosed in the patent application WO 9726824. This patent application discloses an apparatus for monitoring a living body, for example a baby, involving transmitting radiation towards the body, receiving the radiation transmitted after modification by the body and processing the received radiation to determine the position and/or the state of the body, for example to determine if the body is breathing or its heart beating.

A drawback of the known system is the limited precision. Particularly, such a system is unable to precisely determine in which part of an area the living body is located.

### SUMMARY OF THE INVENTION

It is an object of the present invention to provide a presence detection system that is able to detect a presence and a position of a living being, for example a human or an animal, within an area. This object is achieved with the presence detection system according to the invention as defined in claim 1. The presence detection system comprises a first light source providing light of a first spectrum, and a first sensing means, for example a sensor, sensitive to light of the first spectrum. The first sensing means produces a first presence detection signal based on the light of the first spectrum originated from the first light source and reflected from the living being. The presence detection system comprises a processor device for concluding the living being's presence within the area based on the first presence detection signal. The processor device provides a position of the living being within the area based on the intensity of the first presence detection signal and based on the known position of the first light source within the area. Differently from the apparatus known in the art, the presence detection system according to the invention is able to determine not only the living being's presence, but also the position of the living being within the area. The position of the living being is concluded by the processor device based on the intensity of the first presence detection signal. Thus, the system according to the invention does not have the above described problem of the known apparatus.

An embodiment of the presence detection system according to the invention has the feature that the presence detection system further comprises one additional sensing means, a second sensing means sensitive to light of the first spectrum. The second sensing means produces a second presence detection signal based on the light of the first spectrum originated from the first light source and reflected from the living being. The processor device concludes the living being's presence within the area based on the first presence detection signal and the second presence detection signal, wherein the processor device provides the position of the living being within the area based on the intensity of the presence detection signals and based on the known position of the light source within the area.

An embodiment of the presence detection system according to the invention has the feature that the presence detection system further comprises at least one additional light source, a second light source, for providing light of a second spectrum different from the first spectrum, and at least one additional sensing means, a second sensing means, which is arranged to filter the light of the second spectrum. The second sensing means produces a second presence detection signal based on the light of the second spectrum originated from the second light source and reflected from the living being. The processor device concludes the living being's presence within the area based on both, the first presence detection signal and the second presence detection signal or a subset thereof. The processor device provides the position of the living being within the area based on the intensity of the presence detection signals and based on the known position of the light sources within the area. Such a system provides additional advantage resulting in that the position of the living being is more precisely detected. The system with one light source and with one sensing means provides enough information about a distance of the living being in relation to the sensing means. Thus, the living being can be positioned in any point of the imaginary circle having the centre where the sensing means is located and having the radius equal to the detected distance. In the presence detection system with at least two light sources and with at least two corresponding sensing means the position of the living being is determined by the two intersection points of the two imaginary circles each originating from a different light source. The first sensing means and the second sensing means can be comprised by a single sensing means device. An example of such single sensing means device is an array of photodiodes, wherein each of the photodiodes is equipped with a corresponding filter.

An embodiment of the presence detection system according to the invention has the feature that the presence detection system further comprises at least one additional light source, a third light source, for providing light of a third spectrum different from the first spectrum and different from the second spectrum, and at least one additional sensing means, a third sensing means, which is arranged to filter the light of the third spectrum. The third sensing means produces a third presence detection signal based on the light of the third spectrum originated from the third light source and reflected from the living being. The processor device concludes the living being's presence within the area based on the first presence detection signal, the second presence detection signal and the third presence detection signal, or a subset thereof. The processor device provides the position of the living being within the area based on the intensity of the presence detection signals and based on the known position of the light sources within the area. The advantage of this embodiment in respect to the previous embodiment is that the third light source and the third sensing means unambiguously provide the position of the living being. While according to the previous embodiment the position of the living being was one of the two mentioned intersection points, the third light source and the third sensing means provide additional information which enables to conclude in which of the two mentioned points is the living being positioned.

An embodiment of the presence detection system according to the invention has the feature that each of said sensing means comprises a photodiode equipped with a filter, which filter is arranged to filter the light of the corresponding spectrum. The photodiode produces the presence detection signal based on the light of the corresponding spectrum originated from the corresponding light source and reflected from the living being.

An embodiment of the system according to the invention has the feature that each of the presence detection signals, which are produced by the sensing means of the system, comprises a vital sign of the living being, for example a heart rate, a heart rate variation or a breathing rate. An exemplary method to extract a vital sign from the presence detection signal can be to make use of a regular modulation of the intensity caused by the heart beat or respiration of the living being. Next to the temporal modulation of the intensity, also the average intensity can be used as a feature to obtain information about the position of the living being in the area. The processor device uses both features, the average intensity, for the position, and the temporal modulation of the intensity, for the vital sign, for concluding the living being's presence. Such a system, having the feature and functionality to extract a vital sign from the presence detection signal, gives additional security that the living being's presence is correctly concluded since, for example in case that the living being is a human, the known heart rate signal's parameters, in case that the vital sign is the heart rate signal, can be used as additional criteria when concluding the human's presence.

An embodiment of the system according to the invention has the feature that the presence signal represents the vital signals of at least two living beings present within the area. The processor device is able to distinguish between the respective vital signals of the at least two living beings.

The invention further relates to a lighting system comprising the above described presence detection system a light source for illuminating an area. The system is arranged for controlling the light source based on the presence detection.

### BRIEF DESCRIPTION OF THE DRAWINGS

In the following, the invention and further aspects will be described, by way of example, and explained hereinafter, using the following figures:

FIG. 1 schematically shows a first embodiment of a presence detection system according to the invention, wherein the system comprises one light source;

FIG. 2 schematically shows a second embodiment of a presence detection system according to the invention, wherein the system comprises two light sources;

FIG. 3 schematically shows a third embodiment of a presence detection system according to the invention, wherein the system comprises three light sources;

FIG. 4 schematically shows an absorption spectrum of the ohydeoxyhemoglobin;

### DETAILED DESCRIPTION OF THE EMBODIMENTS

In the following description of the preferred embodiments, reference is made to the accompanying drawings which form a part thereof. Specific embodiments, in which the invention may be practiced, are shown in the following description by a way of illustration. It is also understood that other embodiments may be utilized and structural changes may be made without departing from the scope of the present invention. It is noted that the same reference signs will be used for indicating the same or similar parts in the several embodiments.

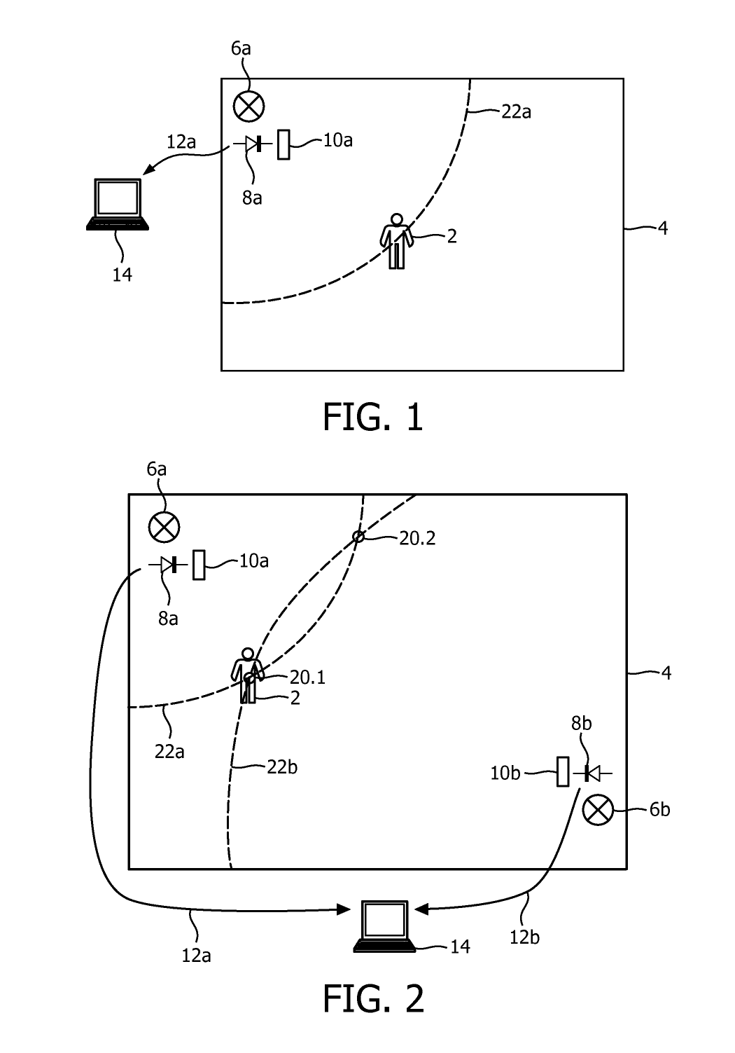

FIG. 1 schematically shows a first exemplary embodiment of the presence detection system for detecting presence of a living being 2 within an area 4 according to the invention. The living being can be a human or an animal and in this embodiment the system detects the presence of a human 2. In this embodiment, the system comprises a first light source 6a providing light of a first spectrum. The first spectrum can be from visible or non-visible light ranges. System further comprises a first sensing means 8a;10a which is arranged to filter the light of the first spectrum. The first sensing means can for example comprise a first photodiode 8a for detecting the light and a first filter 10a for filtering light of the first spectrum. Thus, only light of the first spectrum will pass the first filter and be detected by the first photodiode. Lights of spectra different from the first spectrum will not pass the first filter and consequently will not be detected by the first photodiode. The first sensing means produces a first presence detection signal 12a based on the light of the first spectrum originated from the first light source and reflected from the skin of the human 2. In the embodiment shown in FIG. 1, the first photo diode 8a will detect lights of the first spectrum reflected from the skin of the human 2. The presence detection system further comprises a processor device 14 for concluding the human's presence within the area 4 based on the first presence detection signal. The processor device provides a position 22a of the human 2 within the area based on the intensity of the first presence detection signal 12a and based on the known position of the first light source 6a within the area 4. Based on the first presence detection signal the processor device can conclude a distance of the human in respect to the first light source 6a. This is schematically shown in FIG. 1 by a part of the circular line 22a. Thus, the processor device concludes that the human is positioned in a point of the line 22a. In this way, not only that the human's presence is detected, but additionally an indication of the position of the human is provided.

FIG. 2 schematically shows a second exemplary embodiment of the presence detection system. It has all elements of the first embodiment as described above and as shown in FIG. 1. The system further comprises at least one additional light source, a second light source 6b, for proving light of a second spectrum different from the first spectrum. The system also comprises at least one additional sensing means, a second sensing means 8b;10b which is arranged to filter the light of the second spectrum. Similarly to the first sensing means, the second can comprise a second photodiode 8b and a second filter 10b. The second photodiode 8b produces a second presence detection signal 12b based on the light of the second spectrum originated from the second light source 6b and reflected from the skin of the living being (2). Compared to the first embodiment according to FIG. 1, the second embodiment according to FIG. 2 provides the processor device 14 with an additional signal, the second presence detection signal. Thus, the processor device concludes the human's presence within the area 4 based on both the first presence detection signal 12a and the second presence detection signal 12b, or a subset thereof. The processor device provides the position 20.1;20.2 of the human 2 within the area based on the intensity of the presence detection signals 12a;12b and based on the known position of the light sources 6a;6b within the area 4.

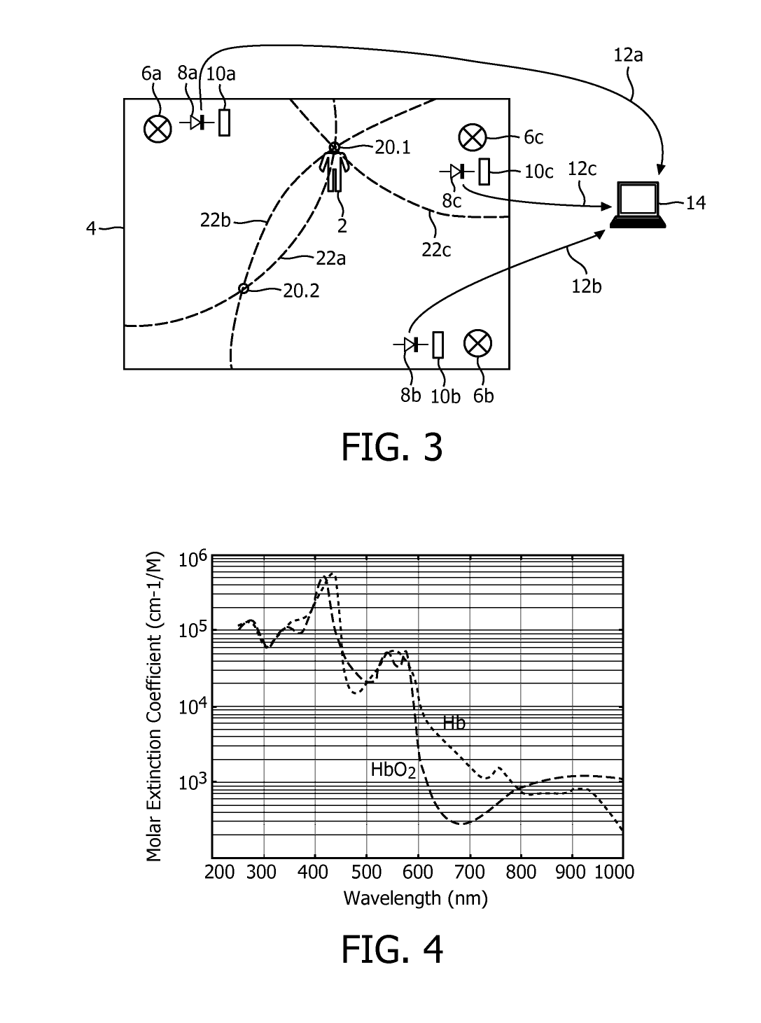

Such a system provides additional advantage in comparison to the first embodiment resulting in that the position of the human is less ambiguously determined. In the system with two light sources according to the second embodiment, the position of the living being is determined by the two intersection points of the two imaginary circles 22a;22b. A third embodiment considers adding a further light source and sensing means. The additional light source, the third light source 6c, according to this embodiment provides the exact position of the living being. In the concrete example shown in FIG. 3 the third sensing means detects the living being in point 20.1. All three sensing means, the first sensing means, the second sensing means and the third sensing means can be comprised by a single sensing means device.

Further advantageous embodiments of the invention comprise systems with more sensing means than light sources. The system comprises all elements of the first embodiment as described above and as shown in FIG. 1. The system further comprises at least one additional sensing means, a second sensing means which is also arranged to filter the light of the first spectrum. Similarly to the first sensing means, the second can comprise a second photodiode and a second filter, which may be identical to the first filter. The second photodiode produces a second presence detection signal based on the light of the first spectrum originated from the first light source and reflected from the living being, however the signal will be different as the second sensing means is positioned at a different position compared to the living being than the first sensing means. Compared to the first embodiment according to FIG. 1, according to this embodiment the processor device is provided with an additional signal, the second presence detection signal. Thus, the processor device concludes the human's presence within the area based on both the first presence detection signal and the second presence detection signal. The processor device provides the position of the human within the area based on the intensity of the presence detection signals and based on the known position of the light source and the sensing means within the area.

As already mentioned, in case that the living being is a person 2, a photodiode 8a;8b;8c is capable to dynamically measure the heart rate, heart rate variability, blood oxygenation and possibly blood pressure from the person. The result of such a measurement is comprised by the presence detection signal 12a;12b;12c.

The system according to the previous embodiments can be provided by a look-up table. The table describes a map of the area represented by e.g. a series of position coordinates and a list having the relation between the distance of the living being from the light source and the intensity of the presence detection signal. The presence detection signal comprises both the positional information, in the form of the average light intensity, and the vital signs information, in the form of a regular modulation of the intensity (in time) caused by the heart beat or respiration. The look-up table preferably contains the positional information. The table may contain the absolute light intensities that correspond to the relevant spatial positions in the area. However, in a preferred embodiment, the table should contain the relative light intensities that correspond to the different spatial positions in the area. In this case, the position of the human will be derived by comparing the relative intensities of the presence detection signals, as being measured by the sensing means, with the associated values which are stored in the look-up table. Having such a list would help the processor device in respect to concluding the presence. Instead of developing software to calculate said distance the processor device needs only to take the relevant information from the predetermined list. However, creation of such list should be done in advance.

The light sources can have the light spectrum in both visible and non visible range. Thus, a spectral bandwidth of the light sources and the adequate sensing means, for example the photodiode array equipped with the adequate filters, can fall outside the visible light wavelengths, i.e. the wavelengths between 400 nm and 700 nm.

FIG. 4 shows the absorption spectrum of the oxhyhemoglobin (HbO2) and deoxyhemoglobin (Hb) used for the measurement of the heart rate of the human. It is clear from FIG. 4 that measurement of the heart rate is possible using the light from a very broad range, at least from 200 to 1000 nanometres (nm).

Referring to FIG. 4, it is apparent that light is strongly absorbed by the blood flow in the person's skin at both ultraviolet (UV) frequencies, i.e. below 400 nm, and at infrared (IR) frequencies, i.e. above 700 nm. As the effect of UV light can be damaging for the skin, it is preferred that the spectral frequencies which are used are IR frequencies where the light is still strongly absorbed by the blood flow in the skin. These are typically frequencies between 700 nm and 1200 nm.

Such an IR based spectrum is suited as both IR light sources, e.g. LED, and photodiodes are readily available across the entire IR wavelength range. FIG. 4 additionally shows that within the wavelength range from around 250 nm to around 1000 nm the light is strongly absorbed by the blood flow in the human's skin. As already said in the previous text that range corresponds to the ultraviolet spectrum, the infrared spectrum and the visible spectrum.

If the photodiode array is used, a one-time calibration of the system may be required in order to translate the spectral colour detected by the photodiode array into a spatial co-ordinate. However, if the illumination pattern is fixed and optionally matched 1:1 to the filters of the photo sensor, the calibration problem will be trivial.

The light sources can use light of non-visible wavelengths since it is not always desirable to illuminate the space with coloured lighting. For this reason, a preferred embodiment of the invention proposes to construct the system whereby the spectrum bandwidth of the light source and the photosensor array filter fall outside the visible light wavelengths, i.e. 350-700 nanometres (nm).

The light is also strongly absorbed by the blood flow in the human's skin at both infrared (IR) wavelengths, above 700 nm, and at ultraviolet (UV) wavelengths, below 400 nm, as it is shown in FIG. 4. As the effect of UV light can be damaging for the skin, it is highly preferred that the spectrum frequencies which are used are IR frequencies where the light is still strongly absorbed by the blood flow in the skin. Such an IR based spectrum is highly suited as both IR light sources, for example LEDs, and photodiodes are readily available across the entire IR wavelength range.

In some embodiments, the sensing means comprise photo sensors having different spectral sensitivities. Such photo sensors sensitive to light of the predefined spectrum can be used instead of the photo sensor equipped with the spectral filter for filtering the light of predefined spectra. In some embodiments, the photo sensors may have intrinsically different spectral sensitivities, whereby they can intrinsically distinguish between light of the different predefined spectra. The intrinsically different spectral sensitivities may be realised by e.g. using different classes of photo sensors such as photodiodes, CCDs, photomultipliers etc. Alternatively the intrinsically different spectral sensitivities may be realised using photo sensors of the same class, such as photodiodes, with different material properties e.g. silicon (Si) based or Gallium Arsenide (GaAs) based; different doping levels in Si etc. Alternatively the different spectral sensitivities can be realised by adding spectral filters.

The invention also proposes specific concepts whereby either the spectral bandwidth of the light source or the photodiode array filter is reduced. In general, the bandwidth of the light source should fall within the bandwidth of the photodiode array filter.

Furthermore, such a system may comprise a discrete or continuous light spectrum. It will be apparent to those experienced in the art that such a system may be created by using a broadband light spectrum or a series of light sources with reduced bandwidth spectrum, or with single frequency light sources, such as lasers and LEDs. Furthermore, it is also possible that each photodiode in the array has a discrete filter.

A further aspect of the invention is a method to determine the spatial position of the living being in the area. The method comprises the performance of a calibration phase to connect the relevant spatial co-ordinates to the corresponding absolute or relative intensities of the presence detection signals. In this manner the look-up table can be created. There are different approaches to such a calibration method to provide a coordinate system. Two possibilities are described in the following text.

A first embodiment of the method is based upon the use of a picture of the space with the light source or sources. The picture provides a map of the space with the spectral illumination at different spatial locations.

A second embodiment of the method is based upon a calibration phase where the reflection of the one or more lights on the skin of a person is measured at different locations. When a person is present in the illuminated space, the light from their skin will reflect the position in the space.

Both approaches result in a look-up table where the position in the space is related to a specific reflected signal.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

### LIST OF REFERENCE NUMERALS

2 a living being
4 an area
6a;6b;6c a light source
8a;8b;8c a photodiode
10a;10b;10c a filter
12a;12b;12c a presence detection system
14 a processor device
20.1;20.2 a position
22a;22b;22c a position line

1. A construction panel suitable for use in as modular construction process, said construction panel comprising:
a) a cast concrete wall member defining two opposed major faces and at least one edge
b) at least one partially embedded support member extending from one major face of the wall member at a distance from at least one edge of at least one major face;
c) wherein the support member is composed of a fibrous composition.

2. A construction panel as claimed in claim 1, wherein the wall member defines a plurality of edges.

3. A construction panel as claimed in claim 1, wherein at least part of at least one of the edges of the major faces is at least partially unimpeded.

4-7. (canceled)

8. A construction panel as claimed in claim 1, wherein the extension of the wall member between the support member and the edge of the wall member defines an extended portion.

9. A construction panel as claimed in claim 8, wherein the extended portion is a linear lip.

10. A construction panel as claimed in claim 8, wherein the extended portion of the wall member extends around a plurality of edges of the wall member.

11. A construction panel as claimed in claim 8, wherein the extended portion of the wall member extends around all the edges of the wall member.

12. A construction panel as claimed in claim 1, wherein the construction panel comprises support members extending along the length of opposed edges of the wall member, and the support members extend from the major face of the wall member at unequal distances from the respective edges of the major face.

13. A construction panel as claimed in claim 8, wherein the construction panel further comprises at least one partially embedded framing support member extending from one major face of the wall member at at least one edge of at least one major face.

14. A construction panel as claimed in claim 13, wherein the extended portion extends around at least some of the edges of the wall member, and a framing support member extends around at least one of the remaining edges of the wall member at the edge of the wall member.

15. A construction panel as claimed in claim 13, wherein the framing support member and the support member are connected to each other.

16. A construction panel as claimed in claim 1, wherein the wall member is substantially rectangular in shape.

17. A construction panel as claimed in claim 16, wherein the wall member is rectangular in shape.

18. A construction panel as claimed in claim 1, wherein at least one support member is substantially L-shaped in cross section.

19. A construction panel as claimed in claim 1, wherein at least one support member is substantially C-shaped in cross section.

20. A construction panel as claimed in claim 1, wherein at least one support member is substantially channel shaped in cross section.

21. A construction panel as claimed in claim 1, wherein the wall member includes internal reinforcing inserts.

22. A construction panel as claimed in claim 8, wherein the extended portion of the wall member includes reinforcing inserts.

23. A construction panel as claimed in claim 8, comprising reinforcing inserts that extend between the extended portion and the rest of the wall member.

24. A construction panel as claimed in claim 21, wherein the reinforcing inserts extend at least partially from the wall member as securing extensions.

25-27. (canceled)

28. A construction panel as claimed in claim 21, wherein the reinforcing inserts are composed of a fibrous composition.

29. A construction panel as claimed in claim 21, wherein the reinforcing inserts are composed of one or more selected from:
a) glass fibre; and
b) carbon fibre.

30. A construction panel as claimed in claim 21, wherein the reinforcing inserts are pre stressed.

31-33. (canceled)

34. A construction panel as claimed in claim 30, wherein the support member is composed of a pultruded fibre composition.

35-36. (canceled)

37. A construction panel as claimed in claim 13, wherein a support member extends along one edge of the wall member, and one selected from a support member and a framing support member extends along an opposed edge of the wall member.

38-39. (canceled)

40. A construction panel as claimed in claim 1, wherein the width of the wall member from edge to edge is between 300-900 mm.

41-48. (canceled)

49. A construction panel as claimed in claim 1, wherein the construction panel includes securing formations for allowing cladding elements to be secured to at least one major face of the wall panel.

50. A construction panel as claimed in claim 1, wherein the support members include batten support formations for supporting support battens.

51. A construction panel as claimed in claim 13, wherein the framing support members include batten support formations for supporting support battens.

52. A construction panel as claimed in claim 1, wherein the construction panel further comprises an integrally formed heating arrangement.

53. A construction panel as claimed in claim 52, wherein the heating arrangement includes a length of piping suitable for The passage of heated fluid, with an inlet passage and an outlet passage.

54. A construction panel as claimed in claim 53, wherein the piping is configured as several lengths of parallel pipes connected to each other.

55-61. (canceled)

62. A construction panel as claimed in claim 1, wherein the wall member includes a recess along an edge adapted for operationally receiving a sealing arrangement.

63. A construction panel as claimed in claim 62, wherein the recess is along an edge on a major face opposed to the major face from which the support members extend.

64. A construction panel as claimed in claim 1, wherein the wall member includes a recess along at least one minor face, said recess adapted for operationally receiving as sealing arrangement.

65. A construction panel suitable for use in a modular construction process, said construction and comprising:
a) as cast planar wall member defining two opposed major faces;
b) at least one partially embedded support member most proximate an edge of the wail member extending from one major face of the wall member;
c) wherein the wall member extends outwardly along the plane of the wall member from the support member to define an extended portion
d) wherein the support member is composed of a fibrous composition.

66. A construction panel as claimed in claim 65, wherein the edges of the extended portion are unimpeded, to thereby allow for the snug engagement of the extended portion against one or more selected from the group of:
construction framing;
b) the extended portion of a similar construction panel;
c) the support member of a similar construction panel; and
an edge of a floor construction.

67-159. (canceled)

160. A wail construction comprising:
a) at least a plurality of construction panels as claimed in claim 1 disposed with the edges of the major faces of adjacent planar wall members at least partially abutting each other; and
b) a structural member disposed intermediate the support members most proximate the abutting edges of the adjacent wall members;
c) wherein the construction panels are secured or securable to the structural member by at least one securing arrangement.

161. A wall construction as claimed in claim 160, wherein the wall construction comprises, at a position secured along at least part of an edge of to major face of at least one construction panel, one or more selected from a framed construction panel comprising:
a) a cast planar wall member defining 2 opposed major faces and at least one minor face; and
b) a pair of partially embedded framing support members extending from at least one major face of the wall member proximate opposed edges of the wall member.

162-176. (canceled)

177. A wall construction as claimed in claim 161, wherein the wall construction includes a sealing arrangement between one or more selected from:
a) adjacent construction panels; and
b) adjacent construction panels and framed construction panels.

178. A wall construction as claimed in claim 177, wherein the sealing arrangement comprises a sealing member received into a combined recess formed by adjacent recesses of adjacent panels.

179. A wall construction as claimed in claim 177, wherein the sealing. arrangement comprises a settable sealing, filler composition received into a combined recess formed by adjacent recesses of adjacent construction panels.

180. A wall construction comprising:
a) a supporting structural formation comprising an upper supporting surface defining an edge formation; and
at least one construction panel as claimed in claim 1,
c) wherein said support member extends substantially horizontally from the wall member and is supported by the upper supporting surface, and the extended portion of the construction panel extends downwardly past the edge formation to below the upper supporting surface.

181. A wall construction as claimed in claim 180, wherein the wall construction includes a securing arrangement for securing the support member to the supporting structural formation.

182. A wall construction as claimed in claim 180, wherein the wall member is distanced from the edge of the supporting structural formation to provide ventilation through the wall construction.

183. A wall construction as claimed in claim 180, wherein the wall construction comprises one or more selected from a frame construction panel comprising:
a) a cast plan wall member defining to opposed major faces and at least one minor face; and
b) a pair of partially embedded framing support members extending from at least one major face of the wall member proximate opposed edges of the wall member.

184. A floor construction comprising:
a) a supporting structural formation comprising an upper supporting surface defining an edge formation; and
b) at least one construction panel as claimed in claim 1;
c) wherein said construction panel is disposed with its
i) extended portion abutting against the upper supporting surface to support the wail member vertically, and
ii) said support member abutting against the edge formation of the supporting structural formation.

185. A floor construction as claimed in claim 180, wherein the floor construction comprises one or more selected from a framed construction panel comprising:
a) a cast plan wall member defining to opposed major faces and at least one minor face; and
b) a pair of partially embedded framing support members extending from at least one major face of the wall member proximate opposed edges of the wall member.

186. A floor construction as claimed in claim 184, wherein the floor construction comprises a plurality of construction panels disposed with an edge of the major faces of adjacent will members proximate each other.

187. A floor construction as claimed in claim 186, wherein the floor construction comprises a plurality of construction panels disposed with the minor faces of adjacent wall members abutting each other.

188. A floor construction as claimed in claim 184, wherein the floor construction comprises at least one framed construction panel secured along an edge of a major face of at least one construction panel.

189. A floor construction as claimed in claim 185, wherein the plurality of construction panels disposed with an edge of their major faces proximate each other are secured to each other by a securing arrangement at abutting support members.

190-192. (canceled)

193. A floor construction as claimed in claim 184, wherein the floor construction also acts as a ceiling construction for a construction level below the floor construction.

194. A floor construction as claimed in claim 184, wherein the floor construction includes a mounting arrangement secured to at least two support members of adjacent construction panels.

195. A floor construction as claimed in claim 194, wherein the floor construction further comprises support battens mounted between at least two mounting arrangements.

196. A floor construction as claimed in claim 195, wherein the wall construction comprises a drywall member mounted to the support battens.

197-201. (canceled)

202. A floor construction as claimed in claim 187, wherein the floor construction includes a sealing arrangement between adjacent construction panels and/or adjacent construction panels and framed construction panels.

203. A floor construction as claimed in claim 202, wherein the sealing arrangement comprises a sealing member received into a combined recess formed by adjacent recesses of adjacent panels.

204. A floor construction as claimed in claim 202, wherein the sealing arrangement comprises a settable sealing filler composition received into a combined recess formed by adjacent recesses of adjacent panels.

205. A roof construction comprising
a) a plurality of construction panels as claimed in claim 1 disposed with the edges of the major faces of adjacent planar wall members proximate each other; and
b) a structural member disposed intermediate the support members most proximate the abutting edges of the adjacent wall members; and
c) wherein the construction panels are secured to the structural member by means of a securing arrangement.

206. A roof construction as claimed in claim 205, wherein the roof construction comprises one or more selected from a framed construction panel comprising:
a) a cast plan wall member defining to opposed major faces and at least one minor face; and
b) a pair of partially embedded framing support members extending from at least one major face of the wall member proximate opposed edges of the wall member

207-208. (canceled)

209. A roof construction as claimed in claim 206, wherein the extended portion of the wail members overlap with a proximate wall member.

210-220. (canceled)

221. A roof construction as claimed in claim 205, wherein at least one of the cast planar wall members is moulded to resemble a plurality of roof tiles on at least one side.

222. A roof construction as claimed in claim 205, wherein the roof construction includes a sealing arrangement between adjacent one selected from the construction panel and the framed construction panel and one selected from a construction panel and a framed construction panel.

223-286. (canceled)

287. A building construction comprising at least one or more selected from a wall construction as claimed in claim 1.

288. (canceled)

289. A modular construction system comprising a construction panel as claimed in claim 1, and;
a) a cast plan wall member defining to opposed major faces and at least one minor face; and
b) a pair of partially embedded framing support members extending from at least one major face of the wall member proximate opposed edges of the wall member.

290-291. (canceled)

292. A modular construction system as claimed in claim 289, wherein the width of the wall member is standardised for each of:
a) said construction panel; and
b) said framed construction panel.

293. (canceled)

294. A modular construction system as claimed in claim 292, wherein the width of the wall member is standardised at between 300-700 mm.

295. A modular construction system as claimed in claim 294, wherein the width of the wall member is standardised at between 500-650 mm.

296. A modular construction system as claimed in claim 295, wherein the width of the wall member is standardised at about 600 mm.

297-302. (canceled)
